(19) United States
(12) Patent Application Publication
(10) Pub. No.: US 2003/0083758 A1
(43) Pub. Date: May 1, 2003

(54) Remote updating of intelligent household appliances

(76) Inventor: Charles G. Williamson, Columbia, MO (US)

Correspondence Address: SONNENSCHEIN NATH & ROSENTHAL, P.O. BOX 061080, WACKER DRIVE STATION, CHICAGO, IL, 60606-1080, US

(21) Appl. No.: 10/003,041

(22) Filed: Nov. 1, 2001

(51) Int. Cl. G05B 11/01; G05B 19/18; G05B 19/42

(52) U.S. Cl. 700/65; 700/19; 700/20; 700/18; 700/86; 700/87; 700/88

(57) ABSTRACT

The invention may be broadly conceptualized as an approach in which a user profile (204) in the memory of a server (104) is remotely configured by use of a graphical interface on a web device (112) and the data contained in the data structure of user profile is sent to and intelligent appliance (116-122) to configure and update the recipe program data in the intelligent appliance (116-122).

### BACKGROUND OF THE INVENTION

1. Technical Field

The invention relates to remote configuration of an intelligent appliance in a network. More particularly, the invention relates to remote configuring and updating of kitchen or household appliances in the network.

2. Related Art

Currently, household appliances such as coffeemakers and ovens are independent and when used require manual programming. Some appliances, such as a coffeemaker, may be configured to have timers for turning the appliance on and off The programming of the timers in these appliances is accomplished at the appliance using manual controls or buttons. Further, it is often impossible to change the configuration or programming of an appliance, such as the auto off timer in a coffeemaker, once the appliance has left the factory.

Another problem with household appliances is for every product cooked, such as a frozen dinner, the user must set the cooking temperature and the time. Dinners may be ruined or homes burned down because of a user erroneously setting the wrong cooking time or temperature. Prior approaches to resolving the erroneous setting problem have included cookbooks that contain bar coded instructions that contain encoded instructions for setting cooking time and temperature. Such appliances include a bar code reader to read the cookbook's bar code associated with a user-selected recipe. However, as new products are introduced in the supermarket or new recipes are created, the cookbooks must be physically updated or replaced.

Furthermore, it is not uncommon for appliances to have clocks that must be initially set and reset after a power outage. Due to the quality of the components in an appliance clock, it is rare when all clocks on respective appliances match and do not drift apart. After some period of time, the clocks on some of the appliances will have to be adjusted if a user desires all clocks to report the same time. Furthermore, clocks have to be reset twice a year in the United States for changes to or from Day Light Savings Time.

Thus, there is a needed in the art for an approach to set cooking time and temperature that is easy to updated while enabling coordination of data between multiple appliances.

### SUMMARY

Intelligent appliances are connected to one or more networks and receive configuration data from a user profile that resides on a server. The user profile receives data that is entered in a graphical interface that enables users to select a plurality of recipe programs and configuration data for downloading to an intelligent appliance over the one or more networks.

The user profile is an entry in a database of user profiles, resides in a server, and is periodically sent to the intelligent appliance. The server is a computing device having a memory that stores the database and is controlled by the controller executing a plurality of instructions. Similarly, the intelligent appliance has a memory and another controller that executes another plurality of instructions.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE FIGURES

The components in the figures are not necessarily to scale, emphasis instead being placed upon illustrating the principles of the invention. In the figures, like reference numerals designate corresponding parts throughout the different views.

FIG. 1 is a diagram of an intelligent controller in communication with a web server via a modem and other appliances via a power line communication unit in accordance with an embodiment of the invention.

FIG. 2 is a diagram of the intelligent controller in communication with the web server and web device through a PSTN of FIG. 1.

FIG. 3 is a block diagram of the intelligent controller of FIG. 2.

FIG. 4 is a web page to select radio stations at the web device of FIG. 2.

FIG. 5 is a web page to set alarms and radio station at the web device of FIG. 2.

FIG. 6 is a web page to enter current stocks at the web device of FIG. 2.

FIG. 7 is a web page to select pre-mix breadmaker recipe programs at the web device of FIG. 2.

FIG. 8 is a web page to select oven recipe programs at the web device of FIG. 2

FIG. 9 is a web page to configure the coffeemaker settings at the web device of FIG. 2.

FIG. 10 is a web page to select microwave recipe programs at the web device of FIG. 2.

FIG. 11 is a block diagram of the coffeemaker with a power line communication unit of FIG. 1.

FIG. 12 is a block diagram of the breadmaker with a power line communication unit of FIG. 1.

FIG. 13 is a block diagram of the microwave oven with a power line communication unit of FIG. 1.

FIG. 14 is a block diagram of the oven with a power line communication unit of FIG. 1.

FIG. 15 is a data structure of a user profile that is stored in the database located on the server of FIG. 1.

FIG. 16 is a flow chart of the process of a code being scanned at an appliance in accordance with an embodiment of the invention.

### DETAILED DESCRIPTION OF THE EXEMPLARY EMBODIMENTS

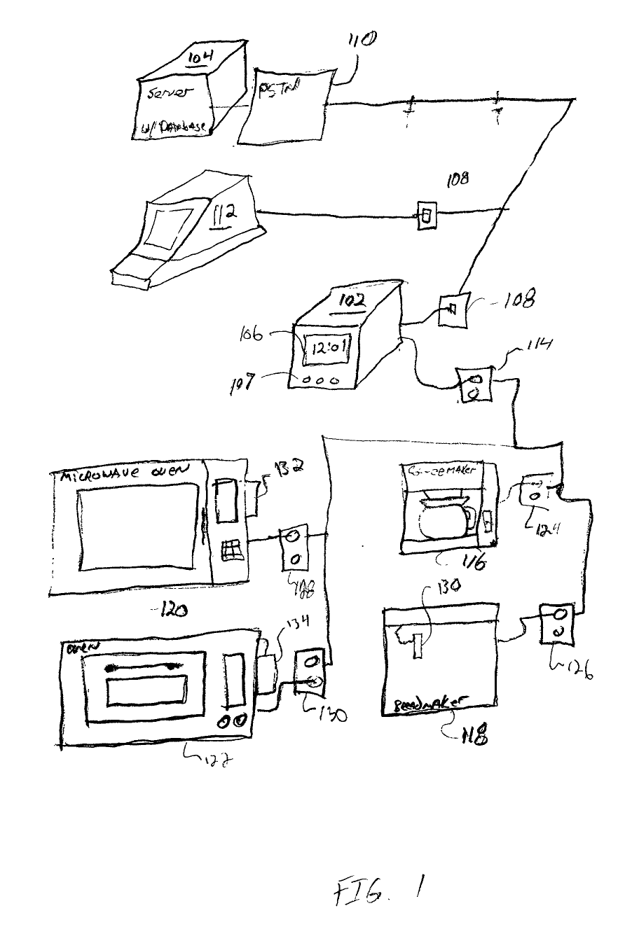

Reference is now made in detail to an embodiment of the present invention, an illustrative example of which is depicted in the accompanying drawings, showing an intelligent kitchen. In FIG. 1, a diagram of an intelligent controller 102 in communication with a web server 104 via a modem and other appliances by a power line communication unit is shown. The intelligent controller 102 has a display 106 and control surfaces 107, such as push buttons and knobs.

The modem in the intelligent controller 102 is connected to a RJ-11 telephone jack 108. The intelligent controller 102 at periodic times uses the modem to initiate a data call through the PSTN 110 to a web server 104. A web device 112, such as a personal computer having another modem is also connected to via another RJ-11 telephone jack 114 and connected by PSTN 110 with web server 104. The web device 112 communicates with the web sever 104 over an Internet Protocol connection. In an alternate embodiment, the intelligent controller 102 may connected through an internet service provider and may even use a cable modem or DSL router to connect with the internet. In yet another embodiment, a different communication protocol may be used by the web device 104 to communicate with web server 106.

The intelligent controller 102 is also connected to the alternating current (AC) home wiring by a power line communication unit communicating through a cord that is plugged into an AC outlet 114. The power line communication unit is able to communicate with other similarly equipped appliances such as coffeemaker 116, breadmaker 118, microwave oven 120, and conventional type oven 122. Each appliance 116-122 has an associated power line communication unit that communicates through an AC outlet 124-130 for two-way communication between the intelligent controller 102 and the appliances 116-122. Examples of power line communication units include X-10, CEBus and POWERBUS power line communication units.

The power line communications between the intelligent controller 102 and the appliances 116-122 enable the synchronization of all of the appliance clocks with the internal clock of the intelligent controller 102. The intelligent controller 102 has an internal clock that is periodically synchronized by communication with the web server 104. The web server 104 maintains accurate time by receiving a timing signal from an atomic clock. In an alternate embodiment, a GPS clock may provide an accurate time signal to the web server and a separate time server may also be implemented in the network. In an alternate embodiment, radio frequency (RF) units may link the intelligent controller 102 and appliances 116-122 with a wireless link. In yet another embodiment, power line communication units provided a wired connection between the intelligent controller 102 and appliances 116-122 and RF units provide a second or redundant path between the intelligent controller 102 and appliances 116-122.

The coffeemaker 116 receives programming for when to turn on from over the power line via the intelligent controller 102. Upon receiving the programming, the coffeemaker 116 reports its state to the intelligent controller 102 where it is displayed. If an “on” time is set, then the coffeemaker 116 reports to the intelligent controller that it is not ready to brew.

Once the user places the water and coffee grounds in the coffeemaker 116, the user presses a button on the coffeemaker 116 that to place the coffeemaker 116 in a ready to brew state. The coffeemaker 116 having informed the intelligent controller 102 that the coffeemaker is in the ready to brew state displays a ready to brew symbol in the display. When the programmed time occurs the coffeemaker 116 starts to brew the coffee and notifies the intelligent controller 116 that it is in the brewing state. The intelligent controller 102 displays a brewing symbol on its display.

When the coffeemaker finishes brewing, it notifies the intelligent controller 102 that coffee is ready. The intelligent controller 102 then displays, a coffee is ready symbol. The coffeemaker turns off automatically after a predetermined time period or manually by a user pushing an off button and informs the intelligent controller 102 of the state change. The intelligent controller 102 then reports in its display that the coffeemaker is not ready to brew. Thus an advantage is achieved by having the intelligent controller 102 remotely display the state of the coffeemaker 116. Further, the time is correctly set and maintained by synchronization with the time maintained by the intelligent controller 102.

The breadmaker 118, microwave oven 120 and conventional oven 122 each have a respective bar code reader 130-134. The bar code readers enables the user of appliances 118-122 to scan a universal product code (UPC) located on a food container. The appliances 118-122 then attempt to identify a recipe program associated with the scanned UPC code. If the recipe program is found, then the appliance is configured by the execution of the recipe program. Thus, an advantage is achieved by being able to configure the cycles of the breadmaker 118 for different types and manufactures of consumer pre-mixed bread mixes. Further the risk of incorrectly preparing the bread is reduced because of less human interaction during the cycle programing of the breadmaker 118.

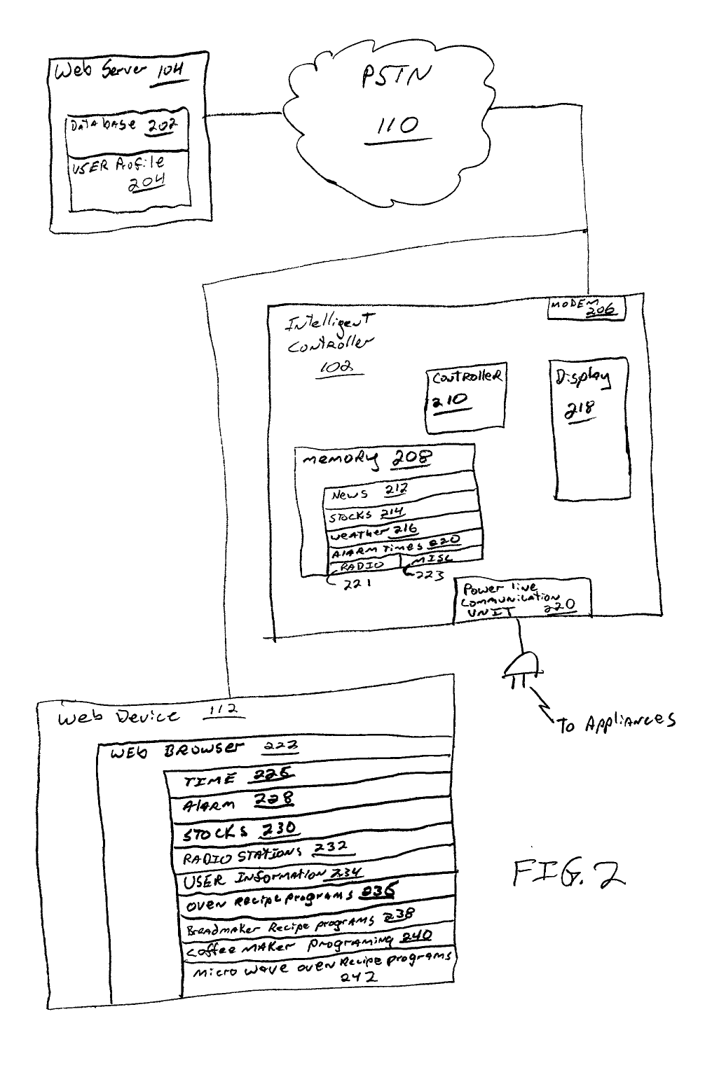

Turning to FIG. 2, a diagram of the intelligent controller 102 in communication with the web server 104 and web device 112 through the PSTN 110 of FIG. 1 is shown. The web server 104 has a database 202 of user profiles with at least one user profile 204 associated with each intelligent controller. The user profile 204 is periodically pushed down to an associated intelligent controller 102 along with time synchronization data and updated user selected data, such as news 212, stock prices 214 and weather reports 216. In an alternate embodiment, time synchronization data and updated user selected data may be pulled down by the intelligent controller 102 from the web server 104. The user selected data is sent from the web server 104 through the PSTN 110 to be received via modem 206 at the intelligent controller 102. The controller 210 stores the user-selected data (news 212, stock prices 214 and weather reports 216) into memory 208. The userselected data stored in memory 208 may then be displayed by the controller 210 on display 218 along with time information.

The user profile 204 stored in the database 202 located on the web server 104 also contains configuration data, such as time zone, selected radio stations, alarm times and settings (“buzz” or a radio station). The alarm times 220 and radio stations 221 configuration data is stored by controller 210 in memory 208 when periodically pushed down to the intelligent controller 102 from the web server 104. Miscellaneous data, such as recipe program updates, new recipe programs, or other text or programs may be received by the intelligent controller 210 and stored in memory 208 in appropriate miscellaneous memory 223. Data stored in memory 208 may also be transmitted to and received from other appliances through a power line communication unit 220.

The user profile 204 is configurable by a web browser 222 being executed on the web device 112 connected by an Internet Protocol connection through PSTN 110 to web server 104. The web browser 222 accesses configuration web pages 224 that are associated with the intelligent controller 102 and other appliances 116-122. A time web page 224 is presented to a user of the web device 112 that allows a user to enter the zip code where the intelligent controller 102 is located. In other embodiments the time web page 224, may be implemented as input fields on another web page, such as a user information web page 234. The zip code is then used by a program on the web server 104 to identify possible radio stations and time zones. In other embodiments, the user may select the time zone and city where the intelligent controller 102 is located. The user may also be presented with a web page 226 to configure the clock function, set alarm web page 228, stock selection web page 230, program radio stations web page 232, user information web page 234, web pages for selections of recipe programs for a oven 236, breadmaker recipe program selection web page 238, coffeemaker programming web page 240, and recipe program selection web page for the microwave oven 242.

Each web page communicates with the web server 104 and may result in the user profile 204 in the database 202 being configured or updated. Changes in the user profile 204 are periodically pushed down to the intelligent controller 102 at predetermined intervals upon the intelligent controller 102 contacting the web server 104. Thus, the ability to change or update programs associated with the user profile is achieved by downloading the changes or updates to appliances 116-122 via the intelligent controller 102. In an alternate embodiment, the web server 104 may contact the intelligent controller 102 and send the data contained in the user profile 204 to the intelligent controller 102 at periodic intervals. In yet another embodiment, the web server may contact the intelligent controller 102, upon configuration of the intelligent controller 102 and/or upon a change being made to the user profile 204. Similarly, in an alternate embodiment, the intelligent controller 102 may synchronize with the web server 104 and user profile 204 upon a predetermined action occurring. Examples of such actions include; a user physically pressing a button to cause synchronization, new appliances being detected on the power line, or receiving a “unknown UPC” message from an appliance.

Intelligent Controller

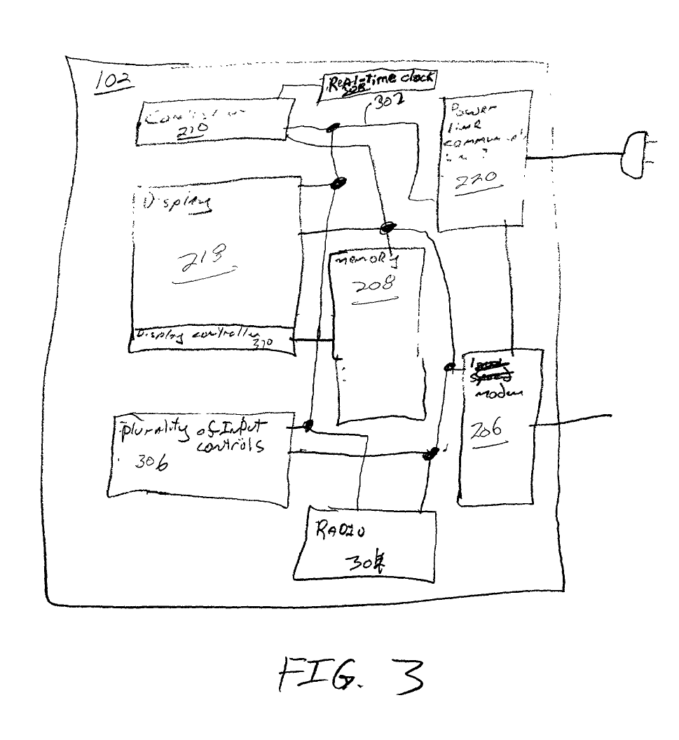

In FIG. 3, a block diagram of the intelligent controller 102 of FIG. 2 is shown. The intelligent controller 102 has a controller 210 that is connected by a bus 302 to the modem 206, the memory 208, the display 218, the power line communication unit 220, a radio 304, a plurality of input controls 306, and a real-time clock 308. The controller 210 is a microprocessor, but in an alternate embodiment may be a reduced instruction set chip (RISC) processor, micro-controller, digital circuits functioning as a controller, analog circuits functioning as a controller, a combination of analog and digital circuits functioning as a controller, or a digital signal processor.

The modem 206 is a low speed 300-14,400 kbps internal modem and is a network interface to PSTN 110. In an alternate embodiment, a higher speed modem or network interface may be used. In yet another alternate embodiment, an external network interface may be used to access the PSTN 110 and connect to the intelligent controller 102 via an external bus such as a serial bus, SCSI bus, or universal serial bus (USB) The modem 206 may also make a connection to the external network buy wireless means, such as wireless Ethernet connection, 900 MHz in home network, cellular connection.

The radio 304 is configurable via data received at the modem 206 by the controller 210. Such configuration information includes preset stations for both the AM and FM radio bands that are stored in memory 208. The radio 304 can be activated either by one of the plurality of input controls 306 or by the controller 210 in response to the real time clock 308. A radio signal is received by an internal antenna (not shown). In an alternate embodiment, the radio 304 may included a weather alert radio in place of or in addition to the radio 304.

The display 218 is able to display text and low-resolution graphics. The display is controlled by a display controller 310 that is in communication with memory 208 and controller 210. The display 208 is a monochrome liquid crystal display (LCD). In an alternate embodiment, a high-resolution display may be used. Further, a color display may be used in yet another embodiment. In other embodiments, other types of displays that are capable of displaying data may be used, including for example cathode ray tubes and plasma displays. The display may even be a touch screen that combines the plurality of input controls 306 with display 218.

A real-time clock 308 having a oscillator is connected to the controller 210. The real-time clock 308 is a digital chip that is programmable by the controller 210 in response to a synchronization signal (time message) being received at modem 206. The real-time clock 308 only has to be accurate enough to maintain time for a period of approximately two weeks, thus allowing for greater variances in component quality. A network indicator appears on the display 218, if a synchronization of the real-time clock 308 has occurred within a preceding two-week period. Thus, an advantage is achieved by maintaining the correct time by synchronization of the real-time clock 308 with the correct time maintained at the web server 104.

The memory 208 is a combination of random access memory (RAM), such as dynamic random access memory (DRAM), synchronous dynamic random access memory (SDRAM), or other types of read/write memory, and of read only memory (ROM), such as programmable read only memory (PROM), electrically erasable programmable read only memory (EEPROM). In an alternate embodiment, the memory may include external semi-permanent memory, such as magnetic disk (hard disk, removable hard disk, floppy disk), optical disk (CD-RW) or external permanent memory (CD-R and DVD-R) The memory 208 is divided into a program portion that controls the operation of the intelligent controller 102 and a data portion that maintains configuration data and variables used and manipulated by the controller 210 upon execution of a program.

The power line communication unit 202 is a unit that transmits a carrier signal that is capable of transporting data between devices over a home's AC wiring that electrical appliances receive power. Thus, the power line communication unit 202 is shown both a power supply for the intelligent controller 102 and a communication unit that enables two-way communication with other appliances that share the AC wiring, but may be implemented separately. Examples of such power line communication approaches include; X-10, CEBUS, and POWERBUS by Domosys Corp. In an alternate embodiment, the power line communication unit 202 may be replaced with a wireless RF unit that establishes a wireless connection between the intelligent controller 102 and other appliances.

The minimum functionality required in the intelligent controller 102 is to convert data received over an external network to the AC power line network enabling two-way communication from the AC power line network to the external network. The communication path to the external network (Internet) is often costly to keep active and requires telephone resources that are only periodically available in a home. So, the intelligent controller 102 acts as a temporary storage unit in the transmission of data. For example, if an appliance scans a UPC and it is unknown to that appliance, a message is sent to the intelligent controller 102 for future transmission to the web server 104 upon synchronization. Additional functionality is added to the intelligent controller 102 for the convenience of the user, such as the display 218, radio 304 and clock 308 with a human perceptible time indicator such as display 218, tones, synthesized voice, light emitting diodes forming a display).

Another slave intelligent controller (not shown) may be in communication with the intelligent controller 102 and act as a second input/display device. The slave intelligent controller has a controller, display, memory, power line communication unit, and plurality of buttons. Information displayed on the intelligent controller 102 is mirrored on the slave intelligent controller. The plurality of buttons 306 on intelligent controller 102 is also mirrored on the slave intelligent controller. Thus, a person may have one intelligent controller 102 and a plurality of slave intelligent controllers in different rooms of a home. In another embodiment, the intelligent controller 102 does not have a display 218 or plurality of button 306, rather the intelligent controller 102 relays the information to be displayed to all the displays on the slave intelligent controller and receives input from the plurality of button on the slave intelligent controllers.

Configuration Web Pages

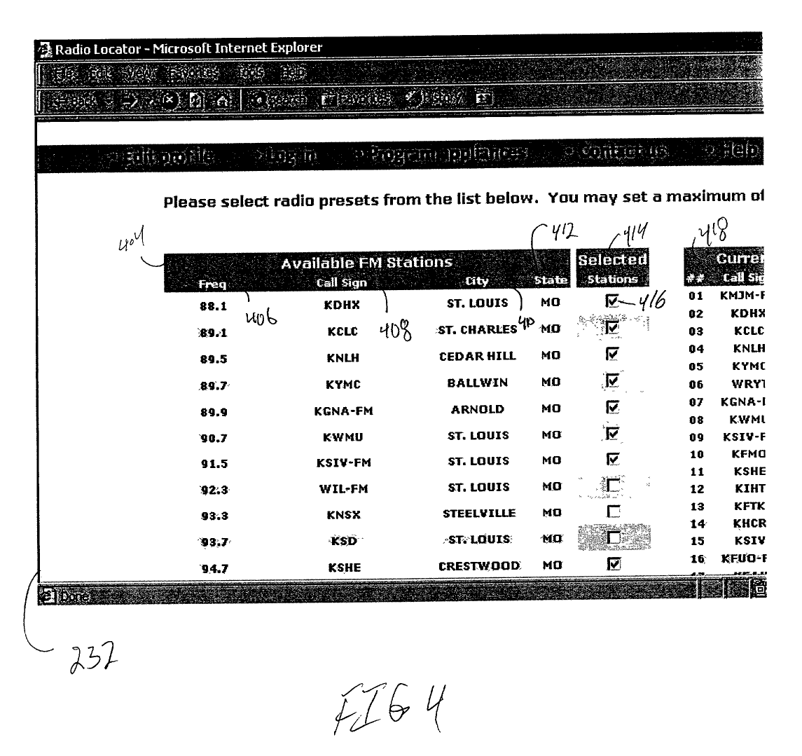

In FIG. 4, a web page to select radio stations 232 at the web device of FIG. 2 is shown. A user of web device 112 accesses the web server 104 and a user profile associated with the intelligent controller 102. The user supplies information relating to the location of the intelligent controller 102 such as a zip code or enters time zone information in a time web page 226 and is then presented with other configuration web pages 224. The web server sends a web page 232 to the web device 112 for configuration of the pre-selected radio stations. The web page identifies the available radio stations 404 by their frequency 406, call sign 408, city 410, and state 412. The user then selects 414 which of the stations should be pre-selected by placing a check in a box 416 associated with the desired station. The web page also displays the radio stations that have already been selected 418. Upon completion, the web page is transmitted to the web server 104 for processing and placement of the data into the users profile 204.

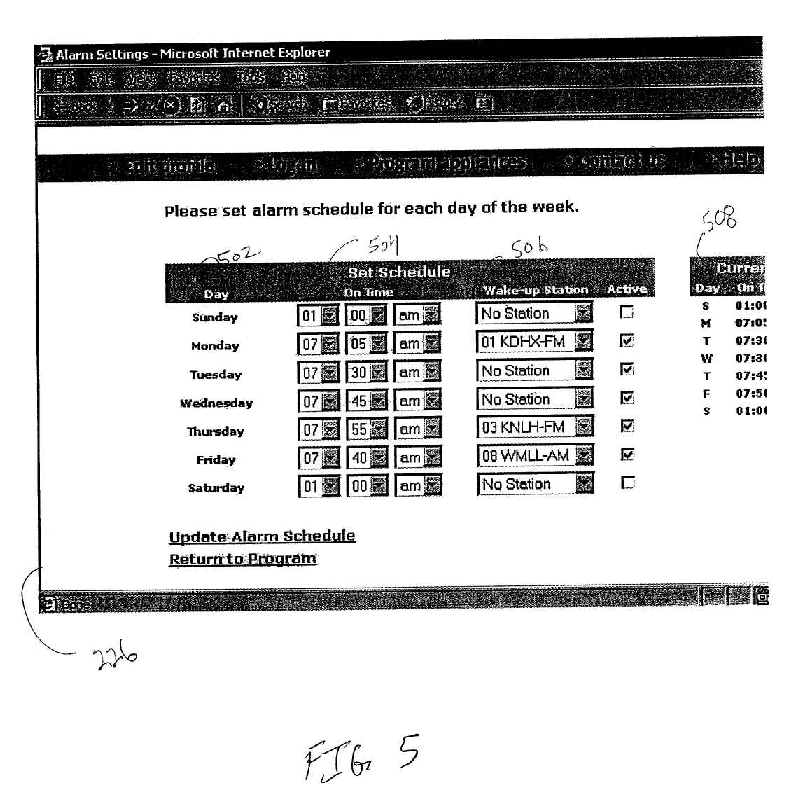

Turning to FIG. 5, a web page to set alarms and radio station 226 at the web device 112 of FIG. 2 is shown. The user is shown the day of week 502 and is presented an input field for selected on time 504. If the intelligent controller includes a radio, then the alarm may have a wake-up station 506 set to a default “buzz” (i.e. no station) or may be set to one of the preset radio stations. Further, the user has to activate the selected alarm by indicating in an input field 508 that the alarm is to be active. The user is able to review the current alarm settings by viewing the current alarm display 508 that is present on the web page 226. The changes that have just been made by a user may not be reflected in the current alarm display 508 until the alarm schedule is updated. Upon completion, the alarm schedule is updated and the data is transmitted to the web server 104 for processing and placement into the users profile 204.

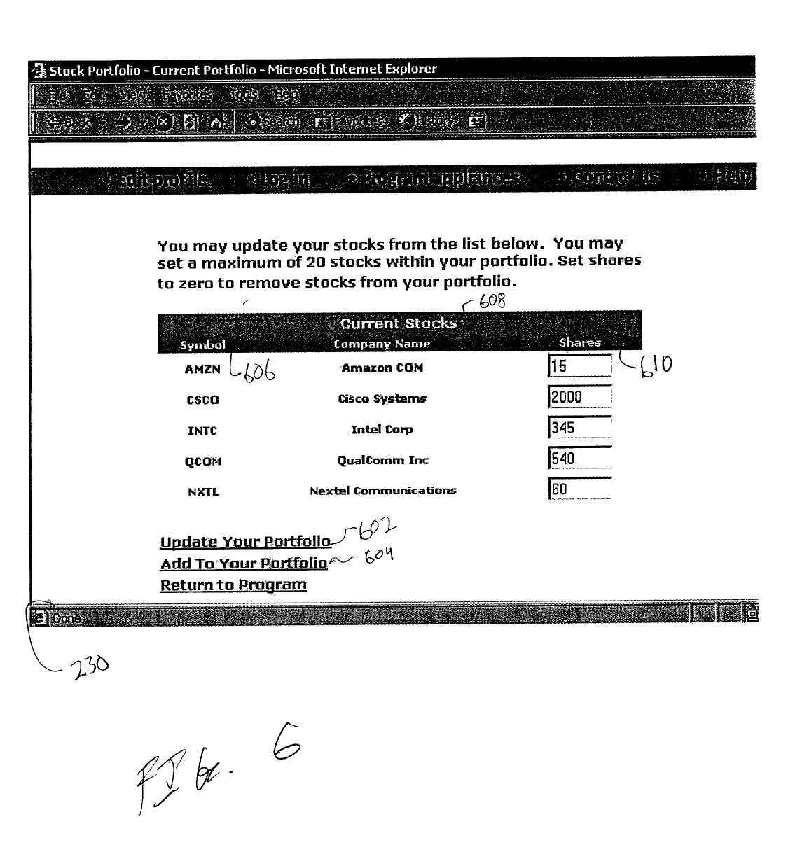

In FIG. 6, a web page 230 to enter current stocks 230 at the web device 112 of FIG. 2 is shown. A user may select the web page 230 to view the current stocks. The user is then presented with his current portfolio that includes stock symbols 606, company names 608 and the number of shares 610. The user is also presented with the options of selecting other web pages such as “Update Your Portfolio” 602 or “Add to Your Portfolio” 604. “Updating Your Portfolio” 602 enables a user to access a web page with input boxes for the number of shares. “Add to Your Portfolio” 604 accesses a web page for adding or deleting stocks from the portfolio. Upon completion, the data from web page 230 is transmitted to the web server 104 for processing and placement into the users profile 204.

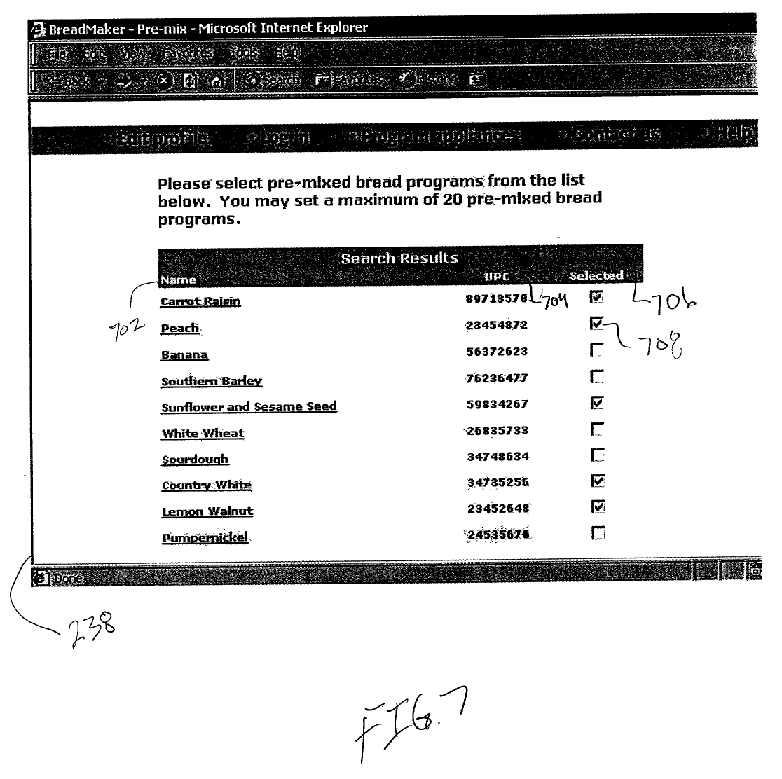

Turning to FIG. 7 a web page 238 to select pre-mix breadmaker recipe programs at the web device 112 of FIG. 2 is shown. A user accesses the web page 238 from the web server 104 and selects the pre-mixed bread recipe programs to be downloaded to the breadmaker. The name of the pre-mixed bread 702 is displayed along with an associated UPC 704. The user selects a pre-mixed bread recipe program 706 by placing a mark in an input box 708. The memory limitation of the bread machine is reflected by the number of pre-mix bread recipe programs that may be selected and downloaded, twenty in the present example. In an alternate embodiment, more recipes may be downloaded if more memory is available or if compression techniques are used. In yet other embodiments, the selection of recipe programs occurs over time automatically with a predetermined number of the most recent used recipe programs being selected. The current selected pre-mix bread recipe programs will be displayed on web page 238 with checks in the selection input field 706. Upon completion, the web page 238 is transmitted to the web server 104 for processing and placement of the data into the users profile 204.

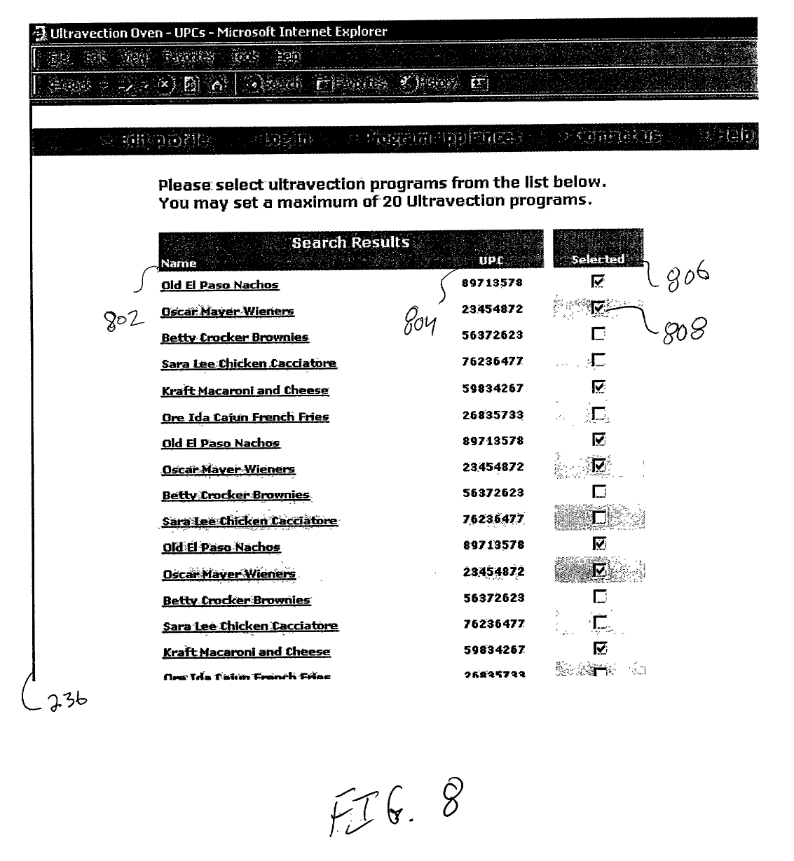

In FIG. 8, a web page 236 to select oven recipe programs at the web device 112 of FIG. 2 is shown. A user accesses the web page 236 from the web server 104 and selects the oven recipe programs to be downloaded to the oven. The names of the oven recipe programs 802 are displayed along with an associated UPC 804. The user selects a oven recipe program 806 by placing a mark in an input box 808. The memory limitation of the oven is reflected by the number of oven recipe programs that may be selected and downloaded, 20 recipe programs in the present example. In an alternate embodiment, more recipe programs may be downloaded if more memory is available or if compression techniques are used. In yet other embodiments, the selection of recipe programs occurs over time with a predetermined number of the most recent recipe programs being selected. The current selected oven recipe programs will be displayed on the web page 236 with checks in the selection input field 806. Upon completion, the data from web page 236 is transmitted to the web server 104 for processing and placement into the users profile 204.

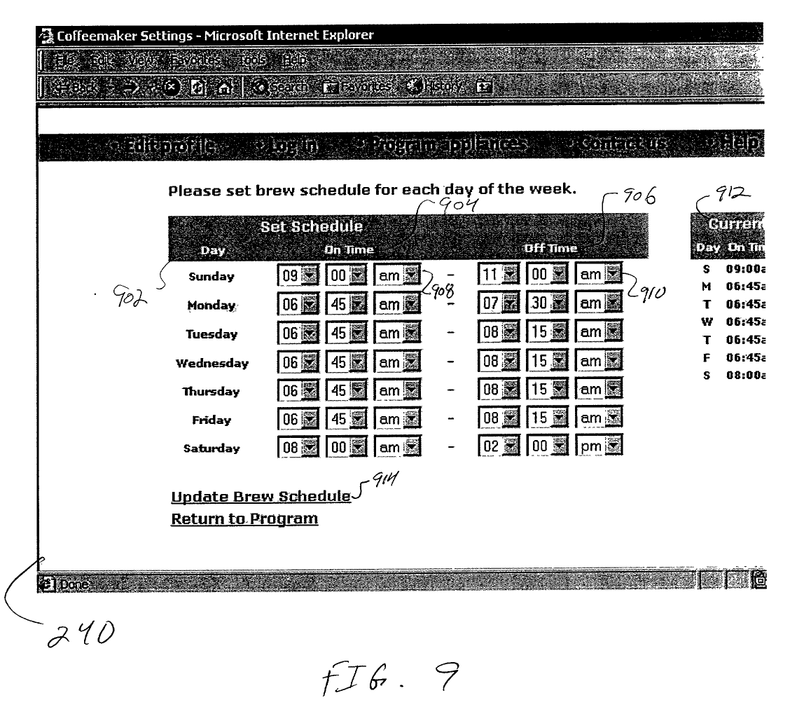

Turning to FIG. 9, a web page 240 to configure the coffeemaker settings at the web device 112 of FIG. 2 is shown. Upon accessing the web page 240 to configure the coffeemaker settings, the user is presented with a schedule for each day of the week 902. The user is shown the current “On Time” 904 and “Off Time” 906. The user is able to change the “On Time” 904 or “Off Time” 906 by accessing the appropriate input box 908 and 910 for example. The user is also shown the current brew schedule 912 for the coffeemaker. The brew schedule is updated by selection “Update Brew Schedule” 914 and the data is updated in the user profile 204 located in the database 202 located at the web server 104.

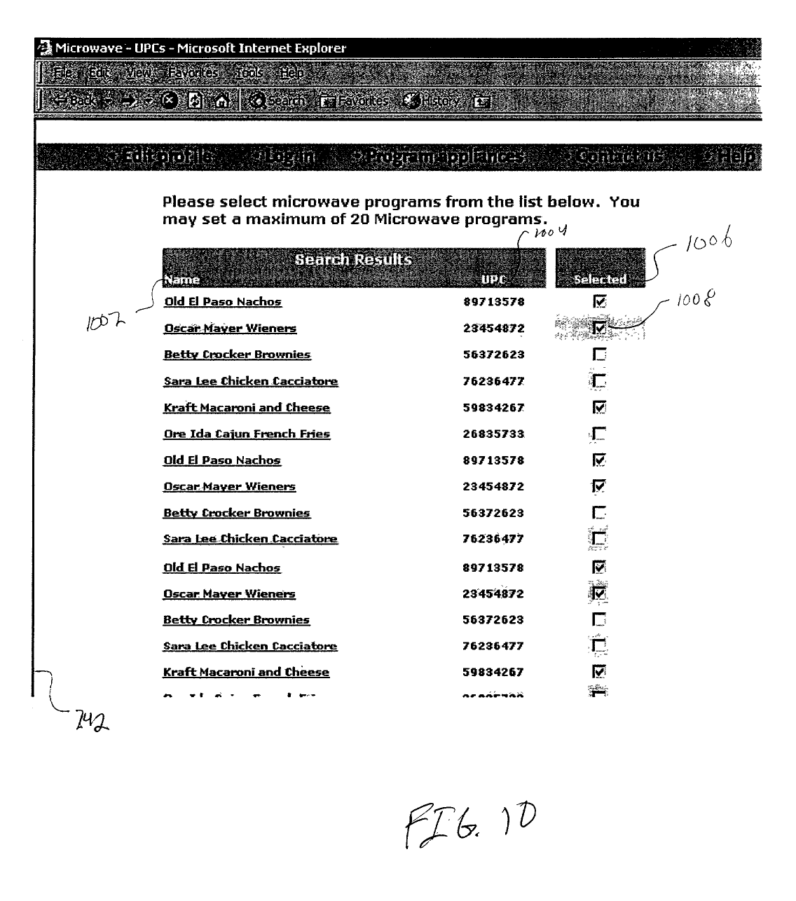

In FIG. 10, a web page 242 to select microwave recipe programs at the web device 112 of FIG. 2 is shown. A user accesses the web page 242 from the web server 104 and selects the microwave oven recipe programs to be downloaded to the oven. The name of the microwave oven recipe program 1002 is displayed along with an associated UPC 1004. The user selects a microwave oven recipe program 1006 by placing a mark in an input box 1008. The memory limitation of the microwave oven is reflected by the number of microwave oven recipe programs that may be selected and downloaded, 20 in the present example. In an alternate embodiment, more recipe programs may be downloaded if more memory is available or if compression techniques are used. In yet other embodiments, the selection of recipes occurs over time with a predetermined number of the most recent used recipe programs being selected. The current selected oven recipe programs will be displayed on the web page 236 with checks in the selection input field 1006. Upon completion, the data from web page 242 is transmitted to the web server 104 for processing and placement into the users profile 204.

Coffeemaker

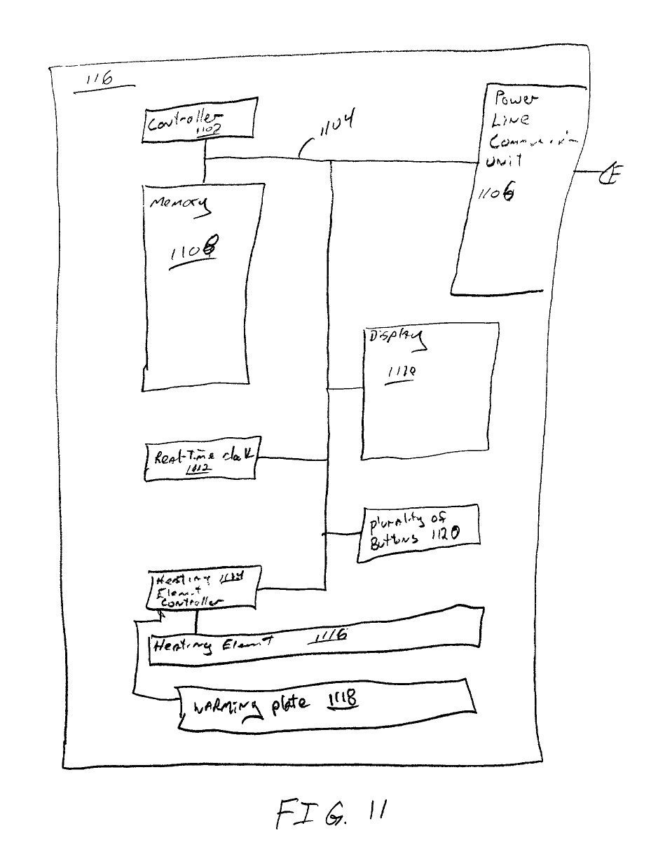

FIG. 11 is a block diagram of the coffeemaker 116 with a power line communication unit 1106 of FIG. 1. The coffeemaker 116 includes a controller 1102 that is connected to a bus 1104 that enables communication with a power line communication unit 1106, memory 1108, display 1110, a real-time clock 1112, and a heating element controller 1114. The heating element controller 1114 is able to electrically control the heating element 1116 and warming plate 1118. A plurality of buttons 1120 may be present and in communication with the controller 1102 to enable manual configuration/operation of the coffeemaker 116.

The controller 1102 is a microprocessor. In an alternate embodiment may be a reduced instruction set chip (RISC) processor, micro-controller, digital circuits functioning as a controller, analog circuits functioning as a controller, a combination of analog and digital circuits functioning as a controller, or a digital signal processor.

The display 1110 is a light emitting diode display and is able to display numbers (time) and human perceptible indicators such as graphics, text, light emitting diodes, light bulbs, audio signal, or even mechanical signal (i.e. flags or arms that are raised and lowered). The indicators indicate when the coffeemaker 116 is on, programmed, ready to brew, brewing, and coffee ready. In an alternate embodiment, the display 1110 may be a liquid crystal non-color display. In yet another alternate embodiment, a high-resolution display may be used. Further, a color display may be used in yet another embodiment. The display may even be a touch screen display that combines the plurality of buttons 1120 with display 1110 in an additional embodiment.

The power line communication unit 1106 is a unit that transmits a carrier signal that is capable of transporting data between devices over the traditional home AC wiring that electrical appliances receive power from. Thus, the power line communication unit 1106 is shown as both a power supply for the coffeemaker 116 and a communication unit that enables two-way communication with the intelligent controller 102 that share the AC wiring. Examples of such power line communication approaches include; X-10, CEBUS, and POWERBUS by Domosys Corp.

The memory 1108 is a combination of random access memory (RAM), such as dynamic random access memory (DRAMs), synchronous dynamic random access memory (SDRAMs), or other types of read/write memory, and of read only memory (ROM), such as programmable read only memory (PROM), electrically erasable programmable read only memory (EEPROM). In an alternate embodiment, the memory may include external semi-permanent memory, such as magnetic disk (hard disk, removable hard disk, floppy disk), optical disk (CD-RW) or external permanent memory (CD-R and DVD-R). The memory is 1108 is divided into a program portion that controls the operation of the coffeemaker 116 and a data portion that maintains configuration data and variables used and manipulated by the controller 1102 upon execution of a program.

In manual operation, the user may set the real-time clock 1112 via the plurality of buttons 1120. The coffeemaker 116 may be turned on or off by one of the plurality of buttons 1120. Once turned on, controller 1102 in the coffeemaker 116 will instruct the heating element controller 1114 to automatically turn off the heating elements after a short period of time (after coffee is made). After two hours, the controller 1102 will automatically instruct the heating element controller 1114 to turn off the warming plate 1118. The controller 1102 is aware of elapsed time by setting timers in the real-time clock 1112.

The coffeemaker 116 may also be configured from the intelligent controller 102 and web device 104. The intelligent controller 102 detects the presence of coffeemaker 116 when the coffeemaker 116 broadcasts a message via the power line communication unit 1106 upon the coffeemaker 116 being energized (plugged-in to the outlet 124) In an alternate embodiment, the intelligent controller 102 periodically checks for new appliances, by broadcasting a message to all appliances connected either to the power line network or by periodically searching for specific types of appliances, such as coffeemaker 116. In yet another embodiment, registration occurs at a web page displayed on the web device 104 that enables the user to enter information into a user profile 204, such as selecting an input box associated with the coffeemaker or a serial number, that is downloaded to the intelligent controller 102.

In an alternate embodiment, the controller 1102 communicating with the intelligent controller 102 via power line communication unit 1106, results in an indicator appearing in the display 1110 to show network communication has been established. The indicator may occur after a time message has been received by the controller 1102 and real-time clock 1112 being set. The indicator will stay light for a predetermined indicator time if communication to the intelligent controller 102 is lost. After that predetermined indicator time, the indicator will be deactivated and no longer visible on the display 1110. In an alternate embodiment, the indicator will be deactivated upon the controller 1102 losing communication via the power line communication unit 1106 with the intelligent controller.

The controller 1102 in the coffeemaker 116 periodically receives time messages from the intelligent controller 102 over the power line communication network that results in the controller 1102 setting the real-time clock 1112. In an alternate embodiment, the controller 1102 receives a specific time message that is transmitted only to the coffeemaker 116. In yet another embodiment, the controller 1102 requests a time message from the intelligent controller via the power line communication unit 1106 when power is initially applied to the coffeemaker 116 or restored after a power outage.

The controller 1102 receives programming information via the power line communication unit 1106 from the user profile data entered on the coffeemaker web page 240 from the intelligent controller 102. The programming of the coffeemaker 116 is by day of week, but in an alternate embodiment may be configurable for multiple time events (multiple times a day, just not once a day). When the coffeemaker 116 is programmed to turn on, the controller 1102 stores the information in memory and sets an event to trigger in the real-time clock 1112. The display 1110 activates a timer indicator to show the coffeemaker 116 has been programmed. Upon the programmed day and time, the controller 1102 is notified of the event by the real-time clock 1112 and notifies the heating element controller 1114 to turn on the heating element 1116 and warming plate 1118. After a preset time, the heating element controller 1114 turns off the heating element 1116 and the coffee is kept hot by the warming plate 1118. During the coffee making operation, the controller 1102 activates an “on” indicator in display 1110. When the heating element controller 1114 turns off the heating element 1116, the controller activates a “ready” display on display 1110.

The controller 1102 sends a message via the power line communication unit 1106 to the intelligent controller 102 when the state of the coffeemaker 116 changes. When the coffeemaker 116 is programmed with times for turning on, the controller 1102 sends a message indicating that the coffeemaker is not ready to brew to the intelligent controller 102. A user prepares the coffeemaker 116 by placing water and coffee grounds in the coffeemaker 116 and by pressing one of the plurality of buttons 1120 to activate the coffeemaker 116. The controller 1102 sends a message to the intelligent controller that the coffeemaker 116 has been activated. When the programmed time occurs, the coffeemaker 116 is turned on and the coffee starts to brew. The controller 1102 then sends a message to the intelligent controller 102 signifying that the coffee is brewing. When brewing is complete, the controller 1102 notifies the intelligent controller 102 by sending a message via the power line communication unit 1106.

After about two hours, the heating element controller 1114 is notified over bus 1104 by the controller 1102 to turn off (auto off) the warming plate 1118. The controller 1102 also deactivates the “on” indicator and the “ready” indicator in display 1110 The controller 1102 also send a message to the intelligent controller 102 to inform the intelligent controller 102 that the coffeemaker 116 is not ready to brew. In an alternate embodiment, the period of time for auto off may be set at a web page and stored in the user profile 204 for downloading to the coffeemaker 116 via the intelligent controller 102.

Breadmaker

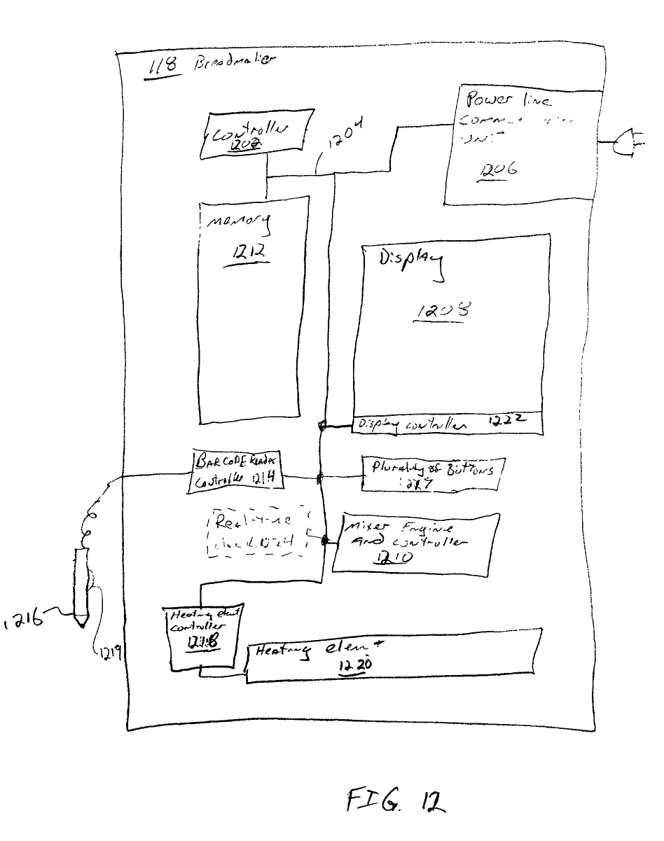

Examining FIG. 12, a block diagram of the breadmaker 118 with a power line communication unit 1206 of FIG. 1 is shown. A controller 1202 is connected by a bus 204 with the power line communication unit 1206, display 1208, mixer engine and controller 1210, memory 1212, bar code reader controller 1214 having a bar code reader 1216, plurality of buttons 1217 and heating element controller 1218. The heating element controller 1218 is connected to heating element 1220 and controls the cycling of the heating element and heat applied to breaking dough. The display 1208 is controlled by a display controller 1222 and converts the messages received from the controller 1202 into human perceptible graphics, such as symbols and letters to form words.

The controller 1202 is a microprocessor. In an alternate embodiment may be a reduced instruction set chip (RISC) processor, micro-controller, digital circuits functioning as a controller, analog circuits functioning as a controller, a combination of analog and digital circuits functioning as a controller, or a digital signal processor.

The display 1208 is able to display text and low-resolution graphics. The display is controlled by a display controller 1222 that is in communication with memory 1212 and controller 1202. The display 1208 is a liquid crystal non-color display. In an alternate embodiment, a high-resolution display may be used. Further, a color display may be used in yet another embodiment. Even through a LCD display has been used with the preferred embodiment, any other types of displays that are capable of displaying data may be used, including cathode ray tubes and plasma displays. The display may even be a touch screen that combines the plurality of buttons 1217 with display 1208.

The power line communication unit 1206 is a unit that transmits a carrier signal that is capable of transporting data between devices over the traditional home AC wiring that electrical appliances receive power from. Thus, the power line communication unit 1206 is shown as both a power supply for the breadmaker 118 and a communication unit that enables two-way communication with the intelligent controller 102 that share the AC wiring. Examples of such power line communication approaches include; X-10, CEBUS, and POWERBUS by Domosys Corp.

The memory 1212 is a combination of random access memory (RAM), such as dynamic random access memory (RAM), synchronous dynamic random access memory (SDRAM), or other types of read/write memory, and of read only memory (ROM), such as programmable read only memory (PROM), electrically erasable programmable read only memory (EEPROM). In an alternate embodiment, the memory may include external semi-permanent memory, such as magnetic disk (hard disk, removable hard disk, floppy disk), optical disk (CD-RW) or external permanent memory (CD-R and DVD-R). The memory is 1212 is divided into a program portion that controls the operation of the breadmaker 118 and a data portion that maintains configuration data and variables used and manipulated by the controller 1202 upon execution of a program.

In manual operation, the user may set select the bread type and crust darkness using the plurality of buttons 1217. The breadmaker 118 may be turned on or off by one of the plurality of buttons 1217. Once turned on, controller 1202 in the breadmaker 118 executes a default breadmaking recipe program in memory 1212 that instructs the mixer engine and controller 1210 heating element controller 1218 to start the bread making process that finishes upon the executed default breadmaking program ending.

The breadmaker 118 may also be configured from the intelligent controller 102 and web device 104. The intelligent controller 102 detects the presence of breadmaker 118 when the breadmaker 118 broadcasts a message via the power line communication unit 1206 upon being plugged-in to the outlet 126. In an alternate embodiment, the intelligent controller 102 periodically checks for new appliances, by broadcasting a message to all appliances connected either to the power line network or by periodically searching for specific types of appliances, such as breadmaker 118. In yet another embodiment, registration occurs at a web page displayed on the web device 104 that enables the user to enter information into a user profile 204, such as selecting an input box associated with the breadmaker 118 or a serial number, that is downloaded to the intelligent controller 102.

The registered breadmaker 118 is downloaded with bread making recipe programs that were previously selected from web page 238. Each of the bread making recipe programs contain a set of instructions for the controller 1202 that control the cycles of the breadmaker 118. If no bread making recipe programs are selected, the breadmaker 118 loads default bread making recipe programs from the user profile 204 via the intelligent controller 102. A bread making recipe program from memory 1212 is selected by scanning a UPC symbol on a pre-mix bread making package using bar code reader 1216. The bar code reader 1216 is shaped like a pen and activates by pressing button 1219. An audible signal is generated upon the successful scanning of a UPC symbol when button 1219 is activated.

The bar code reader controller 1214 receives the read UPC symbol from the bar code reader 1216 and converts the bar code symbol into digital data that is read by the controller 1202 over bus 1204. The controller 1202 then identifies if a bread making recipe program is associated with the digital data received from the bar code reader controller 1214.

Upon identifying the bread making recipe program, the controller 1202 then starts to execute the selected bread making recipe program. Directions for using the pre-mix bread are displayed on display 1208 via display controller 1222. The controller 1202 executing the bread making recipe program initiates each cycle by instructing the mixer engine and controller 1210 along with heating element controller 1218 as to when to turn on and off, and heating temperature (warm to raise dough 90 degrees, hot 350 degrees to bake, and warm 90 degrees to keep bread warm).

During execution of the bread making recipe program, the breadmaker 118 counts down and displays the minutes remaining until the bread is done. The controller 1202 sets a counter that is decrements to track passing of time. In an alternate embodiment, a real-time clock 1224 may be in communication with controller 1202. The real-time clock 1224 receives time messages from the information controller 102 periodically. The real-time clock 1224 then synchronizes to the time maintained by the intelligent controller 102. The real-time clock 1224 functions in similar fashion to the real-time clock 1112 in coffeemaker 116.

If a UPC that was scanned is not found in memory 1212 by controller 1202, then the display controller 1222 is instructed by the controller 1202 to display “Not in Memory” on display 1208. The user manually selects the bread making recipe program to be used with the pre-mix bread. In an alternate embodiment, a default bread making recipe program is used with the pre-mix bread when the UPC that was scanned is not found in memory 1212. An unknown UPC message is formatted by the controller 1202 containing the unknown UPC a sent via the power line communication unit 1206 to the intelligent controller 102. Upon the next synchronization between the database 202 and the intelligent controller 102, the unknown UPC is sent to the web source 104. If the database 202 has a bread making recipe program associated with the unknown UPC, then the user profile 204 is updated with the bread making recipe program and scheduled for download to the intelligent controller 102 upon next synchronization.

In an alternate embodiment, the receipt of an unknown UPC message by the intelligent controller 102 results in an immediate synchronization with the web database 202. If the UPC is not be found in the database, then the user profile 204 is updated with the UPC as a continuing request for a predetermined period (i.e. one month with a maximum limit of 20 UPCs). If the bread making recipe program becomes available during the continuing request predetermined period, then the bread making recipe program is downloaded to the breadmaker 118 via the intelligent controller 102.

Microwave Oven

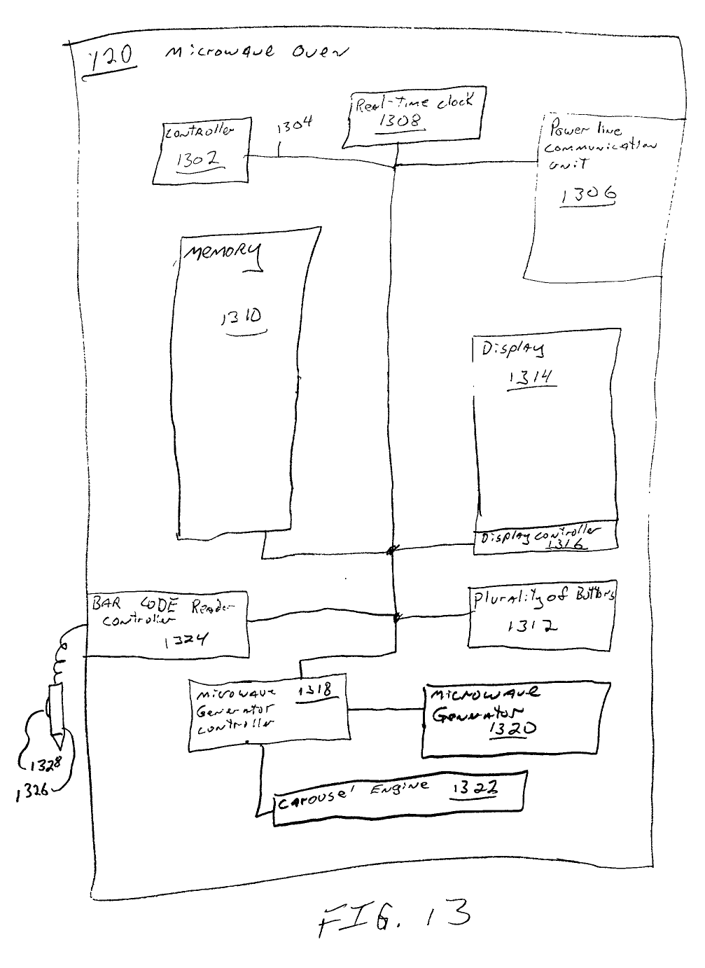

FIG. 13 is a block diagram of the microwave oven 120 with a power line communication unit 1306 of FIG. 1. In the microwave oven 120, a controller 1302 is connected via a bus 1304 to the power line communication unit 1306, a real-time clock 1308, a memory 1310, a plurality of buttons 1312, a display 1314 via a display controller 1316, a microwave generator controller 1318, and a bar code reader controller 1324. The microwave generator controller 1318 controls and is coupled to the microwave generator 1320 and a carousel engine 1322.

The controller 1302 is a microprocessor. In an alternate embodiment may be a reduced instruction set chip (RISC) processor, micro-controller, digital circuits functioning as a controller, analog circuits functioning as a controller, a combination of analog and digital circuits functioning as a controller, or a digital signal processor.

The display 1314 is able to display text and low-resolution graphics. The display is controlled by a display controller 13 16 that is in communication with memory 1310 and controller 1302. The display 1314 is a liquid crystal non-color display in an alternate embodiment, a high-resolution display may be used. Further, a color display may be used in yet another embodiment. Even through a LCD display has been used with the preferred embodiment, any other types of displays that are capable of displaying data may be used, including cathode ray tubes and plasma displays. The display may even be a touch screen that combines the plurality of buttons 1312 with display 1314.

The power line communication unit 1306 is a unit that transmits a carrier signal that is capable of transporting data between devices over the traditional home AC wiring that electrical appliances receive power from. Thus, the power line communication unit 1306 is shown as both a power supply for the microwave oven 120 and a communication unit that enables two-way communication with the intelligent controller 102 that share the AC wiring. Examples of such power line communication approaches include; X-10, CEBUS, and POWERBUS by Domosys Corp. The power line communication unit 1306 enables two-way communication from an appliance to another device and the exchange of data including recipe programs and time synchronization messages.

The memory 1310 is a combination of random access memory (RAM), such as dynamic random access memory (DRAM), synchronous dynamic random access memory (SDRAM), or other types of read/write memory, and of read only memory (ROM), such as programmable read only memory (PROM), electrically erasable programmable read only memory (EEPROM). In an alternate embodiment, the memory may include external semi-permanent memory, such as magnetic disk (hard disk, removable hard disk, floppy disk), optical disk (CD-RW) or external permanent memory (CD-R and DVD-R). The memory is 1310 is divided into a program portion that controls the operation of the microwave oven 120 and a data portion that maintains configuration data and variables used and manipulated by the controller 1302 upon execution of a program.

In manual operation, the user may set time and power level or energy setting of the microwave oven 120 using the plurality of buttons 1312. The microwave oven 120 may be turned on or off by one of the plurality of buttons 1312 and will not start until the cooking chamber containing the carousel is closed. Once turned on, controller 1302 in the microwave oven 120 is activated at the set power level for the time period set by the user. The microwave generator controller 1318 start the oven cooking process that finishes upon the expiration of the time period set by the user. The microwave generator controller activates the microwave generator 1302 that results in high frequency electromagnetic signals that heat items placed in the cooking chamber. The microwave generator controller 1318 also activates the carousel engine 1322 that is connected to a turntable that rotates items in the cooking chamber and results in a more even distribution of the high frequency electromagnetic signals. Similarly, the real-time clock 1308 that generates the time that is displayed in display 1314 may be manually set using the plurality of buttons 1312.

The microwave oven 120 may also be configured from the intelligent controller 102 and web device 104. The intelligent controller 102 detects the presence of microwave oven 120 when the microwave oven 120 broadcasts a message via the power line communication unit 1306 upon being plugged-in to the outlet 128. In an alternate embodiment, the intelligent controller 102 periodically checks for new appliances, by broadcasting a message to all appliances connected either to the power line network or by periodically searching for specific types of appliances, such as microwave oven 120. In yet another embodiment, registration occurs at a web page displayed on the web device 104 that enables the user to enter information into a user profile 204, such as selecting an input box associated with the microwave oven 120 or a serial number, that is downloaded to the intelligent controller 102.

The registered microwave oven 120 is downloaded with microwave oven recipe programs that were previously selected from web page 242. If no microwave oven recipe programs are selected, the microwave oven 120 is loaded from defaults microwave oven recipe programs from the user profile 204 via the intelligent controller 102. A microwave oven recipe program from memory 1310 is selected by scanning a UPC symbol on a consumer package (i.e. food container or box) using bar code reader 1326. The bar code reader 1326 is shaped like a pen and activates by pressing button 1328 An audible signal is generated upon the successful scanning of a UPC symbol when button 1326 is activated.

The bar code reader controller 1324 receives the read UPC symbol from the bar code reader 1326 and converts the bar code symbol into digital data that is read by the controller 1302 over bus 1304. The controller 1302 then identifies if a bread making recipe program is associated with the digital data received from the bar code reader controller 1324. Upon identifying the microwave oven recipe program, the controller 1302 then execute the microwave oven recipe program. Directions for preparing the consumer item are displayed on display 1314 via display controller 1316, and the power level and cooking time are programmed. The user may also be prompted for serving sizes and to proceed to other steps. The user may respond by using the plurality of buttons 1312 to the different prompts on display 1314. The controller 1302 also instructs the microwave generator controller 1318 as to when to turn on, off (cook time), and power level that will be used to cook the consumer product that scanned.

During execution of a microwave oven recipe program, the microwave oven 120 counts down the remaining minutes until the consumer product is done. The controller 1302 sets a counter in the real-time clock 1308 and relays time data to the display controller 1316 that is then shown on display 1314. The real-time clock 1308 receives time messages from the information controller 102 periodically. The real-time clock 1308 then synchronizes to the time maintained by the intelligent controller 102. The real-time clock 1308 functions in similar fashion to the real-time clock 1112 in coffeemaker 116.

If a UPC that was scanned is not found in memory 1310 by controller 1402, then the display controller 1316 is instructed by the controller 1302 to display “Not in Memory” on display 1314. The default microwave oven recipe program is then used with the consumer product. An unknown UPC message is formatted by the controller 1302 containing the unknown UPC a sent via the power line communication unit 1306 to the intelligent controller 102. Upon the next synchronization between the database 202 and the intelligent controller 102, the unknown UPC is sent to the web source 104. If the database 202 contains a microwave oven recipe program associated with the unknown UPC, then the user profile 204 is updated with the microwave oven recipe program and scheduled for download to the intelligent controller 102 upon next synchronization.

In an alternate embodiment, the receipt of an unknown UPC message by the intelligent controller 102 results in an immediate synchronization with the web database 202. If the UPC is not be found in the database, then the user profile 204 is updated with the UPC as a continuing request for a predetermined period (i.e. one month with a maximum limit of 20 UPCs). If the microwave oven recipe program become available during the continuing request predetermined period, then the microwave oven recipe program is downloaded to microwave oven 120 via the intelligent controller 102.

Oven

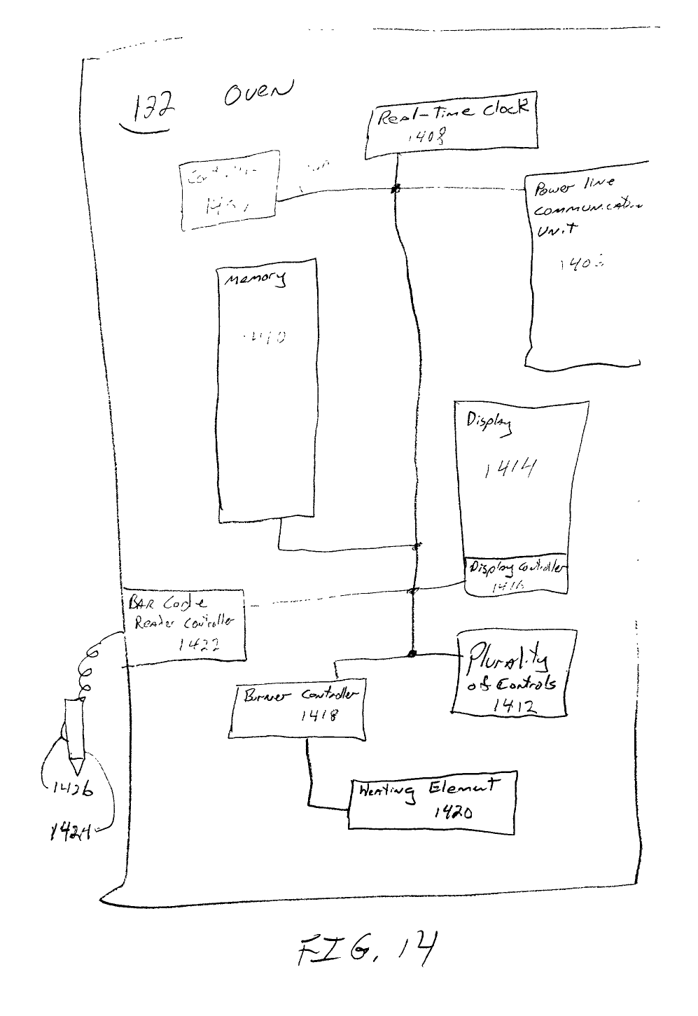

In FIG. 14, a block diagram of the oven 122 with a power line communication unit of FIG. 1 is shown. In the oven 122, a controller 1402 is connected via a bus 1404 to the power line communication unit 1406, a real-time clock 1408, a memory 1410, a plurality of controls 1412, a display 1414 via a display controller 1416, a burner controller 1418, and a bar code reader controller 1422. The burner controller 1418 the temperature of the oven by controlling the heat generated by a heating element. The term oven is used to describe any type of appliance that cooks in an enclosed cavity with heat generated by non-microwave means and include for example gas ovens, electric ovens, convection ovens, or combinations such as an ultravection oven. The heating element may be an electrical heating element or a fossil fuel type burner. The bar code reader 1422 is connected to a bar code reader 1424 having a button 1426 that activates the bar code reader 1422.

The controller 1402 is a microprocessor. In an alternate embodiment may be a reduced instruction set chip (RISC) processor, micro-controller, digital circuits functioning as a controller, analog circuits functioning as a controller, a combination of analog and digital circuits functioning as a controller, or a digital signal processor.

The display 1414 is able to display text and low-resolution graphics. The display is controlled by a display controller 1416 that is in communication with memory 1410 and controller 1402. The display 1414 is a liquid crystal non-color display. In an alternate embodiment, a high-resolution display may be used. Further, a color display may be used in yet another embodiment. Even through a LCD display has been used with the preferred embodiment, any other types of displays that are capable of displaying data may be used, including cathode ray tubes and plasma displays. The display may even be a touch screen that combines the plurality of controls 1412 with display 1414.

The power line communication unit 1406 is a unit that transmits a carrier signal that is capable of transporting data between devices over the traditional home AC wiring that electrical appliances receive power from. Thus, the power line communication unit 1406 is shown as both a power supply for the oven 122 and a communication unit that enables two-way communication with the intelligent controller 102 that share the AC wiring. Examples of such power line communication approaches include; X-10, CEBUS, and POWERBUS by Domosys Corp. Thus, the power line communication unit 1406 enables two-way communication from an appliance to another device and the exchange of data including recipe programs and time synchronization messages.

The memory 1410 is a combination of random access memory (RAM), such as dynamic random access memory (DRAM), synchronous dynamic random access memory (SDRAM), or other types of read/write memory, and of read only memory (ROM), such as programmable read only memory (PROM), electrically erasable programmable read only memory (EEPROM). In an alternate embodiment, the memory may include external semi-permanent memory, such as magnetic disk (hard disk, removable hard disk, floppy disk), optical disk (CD-RW) or external permanent memory (CD-R and DVD-R). The memory is 1410 is divided into a program portion that controls the operation of the oven 122 and a data portion that maintains configuration data and variables used and manipulated by the controller 1402 upon execution of a program.

In manual operation, the user selects an energy setting (temperature) of the oven 120 using the plurality of controls 1412. The user may also be able to set a time period for pre-heating the oven and a cooking time period using the plurality of controls 1412. The oven 122 may be turned on by one of the plurality of controls 1412 that selects the energy setting. Once turned on, controller 1402 in oven 120 executes a default oven recipe program in memory 1410 that instructs the burner controller 1418 to start the heating process by activating the heating element 1420. When the oven finishes execution of the default oven recipe program the controller 1402 instructs the burner controller 1418 to deactivate the heating element 1420 or to keep the oven warm by reducing the heat generated by the heating element 1420. The user may also manually set the real-time clock 1404 so time is properly displayed on display 1414 using the plurality of controls 1412.

The oven 122 may also be configured from the intelligent controller 102 and web device 104. The intelligent controller 102 detects the presence of oven 122 when the oven 122 broadcasts a message via the power line communication unit 1406 upon being plugged-in to the outlet 130. The oven 122 also receives timing messages that enable the controller 1420 to set the real-time clock 1408 and display the correct time on display 1414. In an alternate embodiment the intelligent controller 102 periodically checks for new appliances either by broadcasting a message to all appliances connected to the power line network or by periodically searching for specific types of appliances, such as oven 122. In yet another embodiment, registration occurs at a web page displayed on the web device 104 that enables the user to enter information into a user profile 204, such as selecting an input box associated with the oven 122 or a serial number, that is downloaded to the intelligent controller 102.

The registered oven 122 is downloaded with oven recipe programs that were previously selected from web page 236. If no oven recipes are selected, the oven 122 is loaded from defaults oven recipes from the user profile 204 via the intelligent controller 102. A oven recipe program from memory 1410 is selected by scanning a UPC symbol on a consumer package (i.e. food container or box) using bar code reader 1424. The bar code reader 1424 is shaped like a pen and activates by pressing button 1426. An audible signal is generated upon the successful scanning of a UPC symbol when button 1426 is activated.

The bar code reader controller 1422 receives the read UPC symbol from the bar code reader 1424 and converts the bar code symbol into digital data that is read by the controller 1402 over bus 1404. The controller 1402 then identifies if a oven recipe program that is associated with the digital data received from the bar code reader controller 1422. Upon identifying the microwave oven recipe program, the controller 1402 then starts to execute the oven recipe program. Directions for use of the oven recipe program are displayed on display 1414 via display controller 1416. The user may also be prompted for serving sizes and to proceed in the preparation of the scanned consumer product. The user may respond to such by using the plurality of controls 1412 The controller 1402 also instructs the burner controller 1418 as to when to turn on and off, and what temperature is required to cook the consumer product that was previously scanned.

During execution of a program associated with the selected oven recipe program, the oven 122 counts down the remaining minutes until the consumer product is done. The controller 1402 sets a counter in the real-time clock 1408 and relays time data to the display controller 1416 that is then shown on display 1414. The real-time clock 1408 receives time messages from the information controller 102 periodically. The real-time clock 1408 then synchronizes to the time maintained by the intelligent controller 102. The real-time clock 1408 functions in similar fashion to the real-time clock 1112 in coffeemaker 116.

If a UPC that was scanned is not found in memory 1410 by controller 1402, then the display controller 1416 is instructed by the controller 1402 to display “Not in Memory” on display 1414. The default oven recipe program is then used with the consumer product or the user is prompted to manual set the oven 122. An unknown UPC message is formatted by the controller 1402 containing the unknown UPC a sent via the power line communication unit 1406 to the intelligent controller 102. Upon the next synchronization between the database 202 and the intelligent controller 102, the unknown UPC is sent to the web source 104. If the database 202 contains a recipe associated with the unknown UPC, then the user profile 204 is updated with the oven recipe program and scheduled for download to the intelligent controller 102 upon next synchronization. In an alternate embodiment, the receipt of an unknown UPC message by the intelligent controller 102 results in an immediate synchronization with the web database 202. If the UPC is not be found in the database, then the user profile 204 is updated with the UPC as a continuing request for a predetermined period (i.e. one month with a maximum limit of 20 UPCs). If the oven recipe program becomes available during the continuing request predetermined period, then the oven recipe program is downloaded to the oven 122 via the intelligent controller 102.

Data Structure

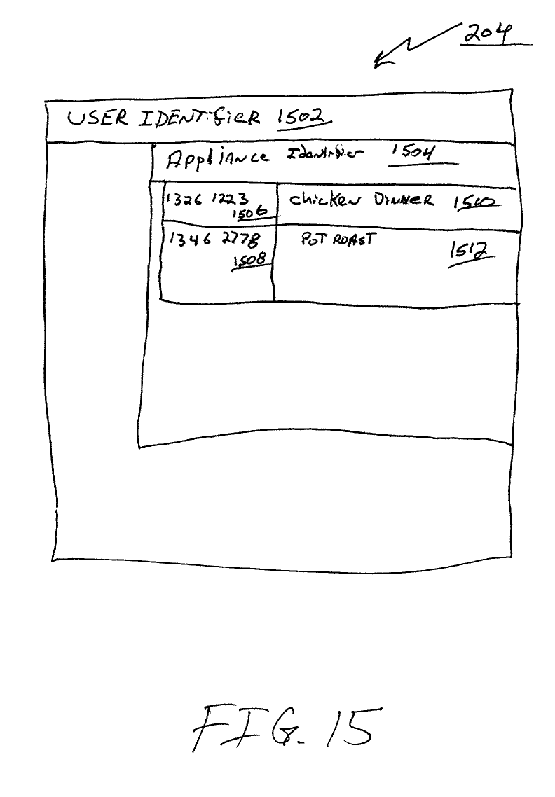

In FIG. 15, a data structure of a user profile 204 that is stored in the database 202 located on server 104 of FIG. 2 is shown. The database 202 at server 104 resides in memory operably associated with the server 104. The user profile 204 is identified in the database 202 by a user identifier 1502. In an alternate embodiment, the user identifier 1502 may be a network address associated with the user profile 204. In yet another embodiment, the user identifier is linked to a network address that is associated with the user profile.

The user identifier 1502 is linked to at least one appliance identifier 1504. Examples of the appliance identifier 1504 include appliance labels such as “Intelligent Controller”, “Microwave Oven”, “Ultravection Oven”, “Breadmaker”, or “Coffeemaker.” If multiple intelligent appliances are located in a common location, the user profile with contain appliance identifiers for each of the intelligent appliances. Each appliance identifier 1504 is a unique identifier to a specific appliance. In an alternate embodiment, the appliance identifier 1504 is an entry in the user profile 204 that is linked to an appliance type. The appliance type is then linked to the user identifier 1502.

The appliance identifier 1504 is linked to a plurality of UPC codes 1506 and 1508 associated with recipe programs 1510 and 1512. At periodic times or upon request by the intelligent appliance, the UPC codes and associated recipe programs are formatted and sent to the intelligent appliance identified by the appliance identifier 1504.

Flow Chart

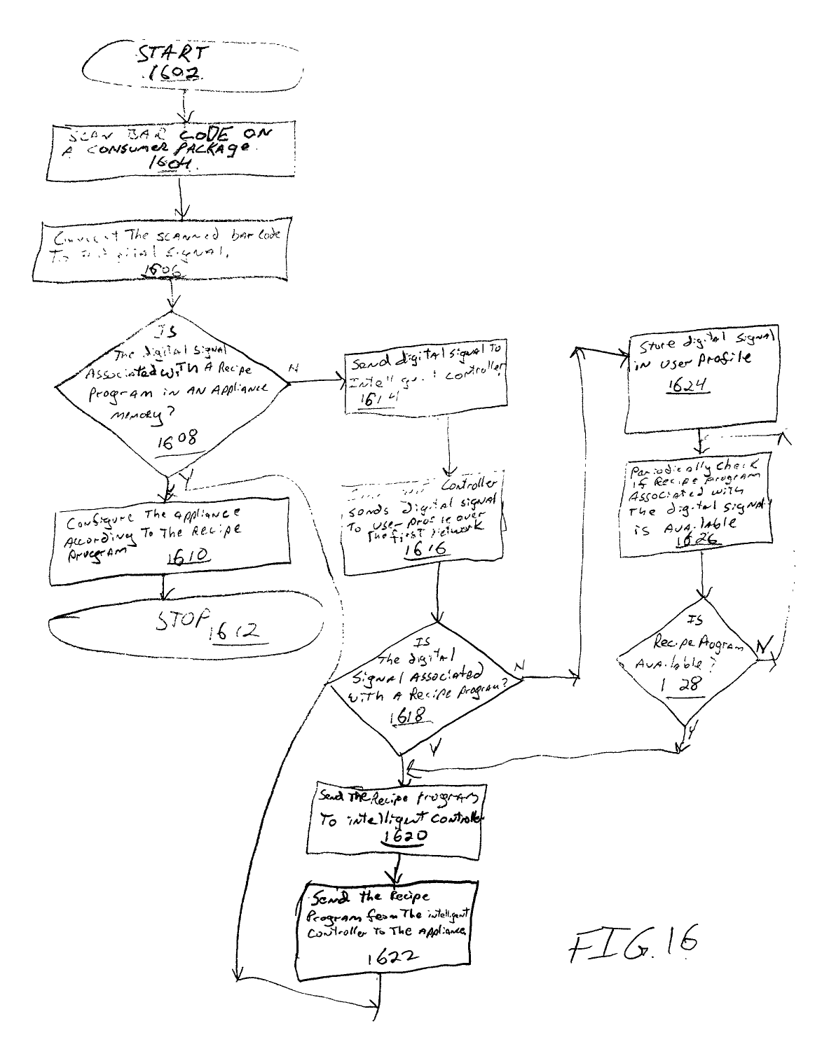

Examining FIG. 16, a flow chart of the process of a code being scanned at an appliance is shown. The process starts (1602) by scanning a bar code, such as a UPC on a consumer package (1604). A bar code reader controller then converts the scanned bar code into a digital signal (1606). The digital signal is then used to access recipe programs stored in memory. If the digital signal is associated with a recipe program in the memory of the appliance (1608), then the appliance is configured according to the recipe program (1610), i.e. time and temperature of a oven or the time and power setting of a microwave oven is set and processing is complete (1612).

If the digital signal is not associated with a recipe program in the memory of the appliance (1608), then the digital signal is sent by the appliance via the home network to the intelligent controller 102 (1614). The intelligent controller 102 then sends the digital signal to the user profile over the first network (PSTN) 110 (1616). The database 202 is then searched to determine if the digital signal is associated with a recipe (1618) in data base 202. If a recipe program is found that is associated with the digital signal (1618), then the recipe program is sent to the intelligent controller 102 (1620) over the first network and the user profile may also be updated to identify the recipe program. The recipe program is then sent from the intelligent controller 102 to the appliance over the home network (1622). The appliance is then configured according the recipe program (1610). In an alternate embodiment, the recipe may not be able to be retrieved in time to configure the appliance, so the user may manually configure the appliance and processing stops (1612). Upon the next scanning of the code, the appliance will be configured according to the recipe program.

If the digital signal is not associated with a recipe program in database 202 (1618), then the digital signal may be stored in the user profile 204 (1624). Periodically the digital signals in the user profile that do not have assigned recipe programs are processed to see if that recipe program is now available (1626). The processing may be configurable to occur daily, weekly, or even monthly. If the recipe program is not available (1628), then processing waits until another periodic check occurs (1626). If the recipe program does exist, then the recipe is sent to the intelligent controller 102 (1620) over the first network. The intelligent controller 102 then sends the recipe program to the appliance (1622) where it is stored in the memory of the appliance and processing stops.

It is appreciated by those skilled in the art that the process shown in FIGS. 15 and 16 may selectively be implemented in hardware, software, or a combination of hardware and software. An embodiment of the process steps employs at least one machinereadable signal-bearing medium. Examples of machine-readable signal bearing mediums include computer-readable mediums such as a magnetic storage medium (i.e. floppy disks, or optical storage such as compact disk (CD) or digital video disk (DVD)), a biological storage medium, or an atomic storage medium, a discrete logic circuit(s) having logic gates for implementing logic functions upon data signals, an application specific integrated circuit having appropriate logic gates, a programmable gate array(s) (PGA), a field programmable gate array (FPGA), a random access memory device (RAM), read only memory device (ROM), electronic programmable random access memory (EPROM), or equivalent. Note that the computer-readable medium could even be paper or another suitable medium, upon which the computer instruction is printed, as the program can be electronically captured, via for instance optical scanning of the paper or other medium, then compiled, interpreted or otherwise processed in a suitable manner if necessary, and then stored in a computer memory.

Additionally, machine-readable signal bearing medium includes computer-readable signal bearing mediums. Computer-readable signal bearing mediums have a modulated carrier signal transmitted over one or more wire based, wireless or fiber optic networks or within a system. For example, one or more wire based, wireless or fiber optic network, such as the telephone network, a local area network, the Internet, or a wireless network having a component of a computer-readable signal residing or passing through the network. The computer readable signal is a representation of one or more machine instructions written in or implemented with any number of programming languages.

Furthermore, the multiple process steps implemented with a programming language, which comprises an ordered listing of executable instructions for implementing logical functions, can be embodied in any machine-readable signal bearing medium for use by or in connection with an instruction execution system, apparatus, or device, such as a computer-based system, controller-containing system having a processor, microprocessor, digital signal processor, discrete logic circuit functioning as a controller, or other system that can fetch the instructions from the instruction execution system, apparatus, or device and execute the instructions.

While various embodiments of the application have been described, it will be apparent to those of ordinary skill in the art that many more embodiments and implementations are possible that are within the scope of this invention. Accordingly, the invention is not to be restricted except in light of the attached claims and their equivalents.

I claim:

1. A method for remote updating of intelligent household appliances, comprising:
selecting a plurality of recipe programs associated with an intelligent appliance;
storing the plurality of recipe programs in a user profile;
downloading the plurality of recipe programs to the intelligent appliance;
receiving a message from the intelligent appliance requesting a new recipe program;
upon finding the new recipe program in a database, transmitting the new recipe to the intelligent appliance; and
obtaining the new recipe program when the new recipe program when the new recipe program is not in the database.

2. The method of claim 1, further comprising:
identifying a user profile associated with the intelligent appliance; and
formatting a message containing the current plurality of recipes in the user profile.

3. The method of claim 1, further comprising:
identifying the possible recipe programs that are capable of being associated with the intelligent appliance.

4. The method of claim 1, further comprising:
generating a list of recipe programs from witch the plurality of recipe programs associated with an intelligent appliance are selected.

5. The method of claim 4, wherein accessing further includes starting a web browser to access the user profile over the internet.

6. The method of claim 1, wherein downloading further includes downloading the plurality of recipes to the intelligent appliance selected from the group consisting of a breadmachine, an intelligent oven and a coffeemaker.

7. A data structure stored in memory, comprising:
a user identifier element that identifies a record in a database; and
an appliance identifier element linked to the user identifier element that identifies an intelligent appliance.

8. The data structure of claim 7, further comprising:
a plurality of recipe program elements linked to the appliance identifier element.

9. The data structure of claim 8, further comprising:
a UPC code element associated with each of the plurality of recipe program elements.

10. A system for remote updating of intelligent household appliances, comprising:
means for selecting a plurality of recipe programs associated with an intelligent appliance;
means for storing the plurality of recipe programs in a user profile;
means for downloading the plurality of recipe programs to the intelligent appliance;
means for receiving a message from the intelligent appliance requesting a new recipe program;
upon finding the new recipe program in a database, means for transmitting the new recipe to the intelligent appliance; and
means for obtaining the new recipe program when the new recipe program when the new recipe program is not in the database.

11. The method of claim 10, further comprising:
means for identifying a user profile associated with the intelligent appliance; and
means for formatting a message containing the current plurality of recipes in the user profile.

12. The system of claim 10, further comprising:
means for identifing the possible recipe programs that are capable of being associated with the intelligent appliance.

13. The system of claim 10, further comprising:
means for generating a list of recipe programs from witch the plurality of recipe programs associated with an intelligent appliance are selected.

14. The system of claim 13, wherein means for accessing further includes means for starting a web browser to access the user profile over the internet.

15. The method of claim 10, wherein means for downloading further includes means for downloading the plurality of recipes to the intelligent appliance selected from the group consisting of a breadmachine, an intelligent oven and a coffeemaker.
